(19) United States
(12) Patent Application Publication
(10) Pub. No.: US 2026/0357857 A1
(43) Pub. Date: Nov. 12, 2026

(54) ELECTROMAGNETIC COIL ASSEMBLY, ASSOCIATED VISCOUS CLUTCH, AND ASSOCIATED METHOD

(71) Applicant: HORTON, INC., Roseville, MN (US)

(72) Inventors: Tristan Carlson, Woodbury, MN (US); Bastian Brand, Schonungen (DE)

(21) Appl. No.: 19/489,768

(22) PCT Filed: Apr. 22, 2024
(86) PCT No.: PCT/US2024/025660

§ 371 Date: Dec. 3, 2025

Related U.S. Application Data
(60) Provisional application No. 63/509,106, filed on Jun. 20, 2023.

(51) Int. Cl. F16D 35/02; H01F 27/02; H01F 27/28; H01F 27/40

(52) U.S. Cl. CPC F16D 35/024; H01F 27/02; H01F 27/28; H01F 27/402

(57) ABSTRACT

An electromagnetic coil assembly for use with a viscous clutch can include a coil housing made of a magnetic flux-conducting metallic material and having an annular cup shape, a winding that forms multiple turns within the coil housing, a cutout in the coil housing that interrupts the magnetic flux-conducting metallic material, and a Hall effect sensor aligned with the cutout. Also disclosed is a viscous clutch assembly, and a method of making a viscous clutch assembly. Additionally, a viscous clutch electrical connection and anti-rotation assembly is disclosed.

### FIELD

The present invention relates generally to electrical and anti-rotation assemblies and systems for use with electromagnetic coils suitable for use with viscous clutches, viscous clutch assemblies including the same, and associated methods of making and using the same.

### BACKGROUND

Clutches are used to drive cooling fans in vehicular applications and in a variety of other settings. A variety of dry friction clutches and fluid friction viscous clutches are available for these purposes. Viscous clutches offer advantages by enabling electrical control in a continuously variable manner.

Viscous clutches are often electromagnetically operated. An electromagnetic coil (or solenoid) is used to actuate a mechanical valve system, which regulates a volume of a shear fluid (such as silicone oil) present in a working chamber and, in turn, controllably changing an output speed of the clutch relative to an input speed. In this way, viscous clutches allow for continuously variable control of a slip speed of the clutch, such that the output speed can be selectively controlled from approximately 0-100% of the input speed whenever there is a torque input to the clutch. The electromagnetic coil is electrically connected to an external controller by a wire leading to a connector and, in some applications, further includes a Hall effect sensor to measure the output speed of the clutch. Some clutches are mounted on a rotationally stationary journal bracket, which provides a non-rotating mounting location for a magnetic coil in some applications. In other prior art systems, such as for clutches with a “live” (rotatable) center shaft and/or those mounted directly to a drive shaft of an engine or motor, an anti-rotation feature such as a tether is used to hold the wire and electromagnetic coil steady (that is, rotationally stationary) relative to the spinning clutch. Use of a non-rotating electromagnetic coil avoids the need for slip rings, brushes, or similar mechanisms to transmit electrical power and/or signals across a rotating interface, which avoids potential problems with such components wearing out or failing during use.

A variety of different prior art systems have been used to house the magnet coil wire, speed sensor and speed sensor wires, and anti-rotation bracket (ARB) features. For example, FIG. 1 illustrates a prior art two-part system in which the electromagnetic coil is built into the clutch, and the ARB bolts to the electromagnetic coil. The Hall effect sensor is located inside the ARB and uses fan screws on the clutch as speed sensing targets. However, the design shown in FIG. 1 is expensive to manufacture, and problems can arise if the distance between the Hall effect sensor and the fan screw heads is incorrect. A system like that shown in FIG. 1 is available with VS™ brand directly controlled fan drives from Horton, Inc. (Roseville, MN, USA).

FIG. 2 illustrates another prior art system that uses an injection molded/potted electromagnetic coil/connector combination with an embedded Hall effect sensor and ARB cable. The ARB cable is permanently attached to this style of coil, making it non-user-serviceable and non-replaceable once it is installed. This design seals the Hall effect sensor inside the coil/connector, and a magnetic flux guide insert (or flux transfer insert) in a clutch housing is used as a speed sensor target, which removes the variability of using the fan screw heads to sense speed but requires a new coil part number for a different length of ARB cable and users/customers are generally required to supply the mating connector. Sometimes vehicle manufacturers and/or other users/customers have additional requirements prohibiting “jumpers,” meaning electrical cables with one connector on each end, which the design shown in FIG. 2 may require. A system like that shown in FIG. 2 is available with LCV® brand fan drives from Horton, Inc. (Roseville, MN, USA).

FIG. 3 illustrates yet another prior art system that utilizes an injection molded electromagnetic coil. The Hall effect sensor is inside the injection molded portion, and a magnetic flux guide insert in a clutch housing is used as a speed sensor target (as with the system shown in FIG. 2). A rubber hose around the electromagnetic coil cable is used as an ARB feature, and a connector is added to the end of the coil cable per user/customer requirements. The system shown in FIG. 3 requires a new part number for different electrical cable lengths, different ARB hose lengths, and different connector types. It is also potentially susceptible to water leakage and the ARB hose damaging the coil cable (fretting). An example of a system like that of FIG. 3 is disclosed in PCT International Patent App. Pub. No. WO2021/151110A1. A system like that shown in FIG. 3 is also available with LCX™ brand fan drives from Horton, Inc. (Roseville, MN, USA).

Some challenges presented with prior art electromagnetic coil electrical connections and ARB features include that it is desirable for manufacturers to provide a single basic clutch, whereas users/customers, such as vehicle manufacturers, often have different requirements, such as the need for different types of electrical connectors, different lengths of electrical cables to reach mating components, etc. Moreover, during use, electrical cables and ARB features for a clutch may be subject to vibration, forces due to rotation of the clutch and/or airflows from a driven fan, and/or contact with nearby objects (e.g., debris, drive belts). In general, it is desired to have electrical connectors and ARB features that are compatible with available installation location space (e.g., inside vehicle engine or motor compartments), are reliable, allow for reasonably accurate speed sensing, are reasonably resistant to wear or degradation, are relatively simple and inexpensive to fabricate, are relatively low in mass, facilitate end-user-replaceability (that is, field serviceability) and are relatively adaptable to a variety of user/customer requirements, particularly regarding electrical cables and connectors.

### SUMMARY

In one aspect, an electromagnetic coil assembly for use with a viscous clutch can include a coil housing made of a magnetic flux-conducting metallic material and having an annular cup shape, a winding that forms multiple turns within the coil housing, a cutout in the coil housing that interrupts the magnetic flux-conducting metallic material, and a Hall effect sensor aligned with the cutout.

In another aspect, a viscous clutch assembly can include a rotor, a housing rotatable relative to the rotor, a working chamber located between and exposed to both the rotor and the housing, a reservoir to hold a supply of a shear fluid, a valve assembly that is magnetically controllable to regulate flow of the shear fluid between the reservoir and the working chamber, and an electromagnetic coil assembly. The valve assembly and the electromagnetic coil assembly are operably connected by way of a flux circuit. The electromagnetic coil assembly can include a coil housing made of a magnetic flux-conducting metallic material, a winding that forms multiple turns within the coil housing, and an electrical connector configured to be matingly engageable to another connector to form one or more external electrical connections. The electrical connector can include an inner electrical conductor portion that provides one or more discrete electrical connections, at least one of which is electrically connected to the winding, and one or more fastener openings each located alongside the inner electrical conduction portion, such that at least one of the one or more fastener openings establishes an anti-rotation tether point for the electromagnetic coil assembly. The electromagnetic coil assembly is rotationally stationary. The inner electrical conductor portion can be configured to form a seal with another connector upon engagement to another connector.

A method of assembling a viscous clutch assembly can include providing a clutch pack that includes a housing, a rotor, a reservoir, and a valve assembly, securing an electromagnetic coil assembly to the clutch pack (the clutch pack and the electromagnetic coil assembly can both be supported on a center shaft), the electromagnetic coil assembly including an electromagnetic coil and a coil-side connector electrically connected to a winding of the electromagnetic coil, electrically connecting a cable-side connector to the coil-side connector, such that the electromagnetic coil is electrically connected to the cable-side connector, with the cable-side connector being electrically connected to an electrical cable positioned external to the clutch pack, mechanically securing the cable-side connector and the coil-side connector together, and connecting an anti-rotation tether to the cable-side connector and the coil-side connector with a mechanical fastener. The anti-rotation tether can be directly connected to the cable-side connector with the mechanical fastener, and the cable-side connector, the coil-side connector, and the anti-rotation tether can be secured together with the mechanical fastener at a location spaced from respective inner electrical conductor portions of the cable-side connector and the coil-side connector that electrically connect the cable-side connector to the coil-side connector.

A method of making viscous clutch assemblies can include providing a first clutch pack that includes a first housing, a first rotor, a first reservoir, and a first valve assembly, providing a second clutch pack that includes a second housing, a second rotor, a second reservoir, and a second valve assembly (the first clutch pack and the second clutch pack can have the same configuration), securing a first electromagnetic coil assembly to the first clutch pack (the first clutch pack and the first electromagnetic coil assembly can both be supported on a first center shaft), the first electromagnetic coil assembly including a first electromagnetic coil and a first coil-side connector electrically connected to the first electromagnetic coil, securing a second electromagnetic coil assembly to the second clutch pack (the second clutch pack and the second electromagnetic coil assembly can both be supported on a second center shaft), the second electromagnetic coil assembly including a second electromagnetic coil and a second coil-side connector electrically connected to the second electromagnetic coil (the second coil-side connector having a different configuration than the first coil-side connector), electrically connecting a first cable-side connector to the first coil-side connector such that the first electromagnetic coil is electrically connected to the first cable-side connector and the first cable-side connector is electrically connected to a first electrical cable positioned external to the first clutch pack, the first electrical cable having a first length, electrically connecting a second cable-side connector to the second coil-side connector, such that the second electromagnetic coil is electrically connected to the second cable-side connector and the second cable-side connector is electrically connected to a second electrical cable positioned external to the second clutch pack, the second electrical cable having a second length that is different from the first length of the first electrical cable, the second cable-side connector having a different configuration than the first cable-side connector such that the first coil-side connector is incompatible with the second cable-side connector and the second coil-side connector is incompatible with the first cable-side connector, connecting a first anti-rotation tether to the first cable-side connector and the first coil-side connector with a first mechanical fastener, such that the first anti-rotation tether is directly connected to the first cable-side connector with the first mechanical fastener, and connecting a second anti-rotation tether to the second cable-side connector and the second coil-side connector with a second mechanical fastener, such that the second anti-rotation tether is directly connected to the second cable-side connector with the second mechanical fastener.

The present summary is provided only by way of example, and not limitation. Other aspects of the present invention will be appreciated in view of the entirety of the present disclosure, including the entire text, claims, and accompanying figures.

### BRIEF DESCRIPTION OF THE DRAWINGS

FIGS. 1-3 are partial side perspective views of three alternative prior art viscous clutches each having electromagnetic coil electric cable and anti-rotation tether features.

FIG. 4A is a cross-sectional view of a viscous clutch and an electromagnetic coil electrical cable connection and anti-rotation assembly according to an embodiment of the present invention.

FIG. 4B is a cross-sectional perspective view of a portion of the viscous clutch and an electromagnetic coil electrical cable connection and anti-rotation assembly.

FIG. 5 is a top perspective view of a portion of the viscous clutch and an electromagnetic coil electrical cable connection and anti-rotation assembly.

FIGS. 6A and 6B are left-and right-side perspective views, respectively, of the electromagnetic coil electrical cable connection and anti-rotation tether assembly connected to the viscous clutch.

FIG. 7 is an exploded perspective view of the electromagnetic coil electrical cable connection and anti-rotation tether assembly of FIGS. 6A and 6B, shown without an overmolded covering.

FIG. 8 is an exploded, sectional perspective view of the electromagnetic coil electrical cable connection and anti-rotation tether assembly and the viscous clutch, taken along line 8-8 of FIG. 7.

FIG. 9 is a sectional view of the electromagnetic coil electrical cable connection and anti-rotation tether assembly and the viscous clutch, taken along line 9-9 of FIG. 6B, shown without the overmolded covering.

FIG. 10 is a sectional view of a portion of another embodiment of an electromagnetic coil assembly, shown in isolation.

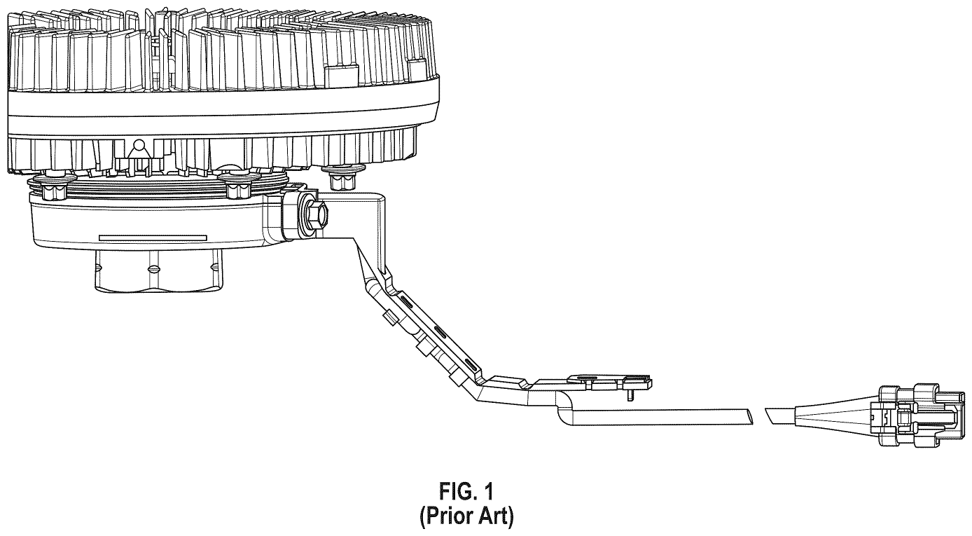

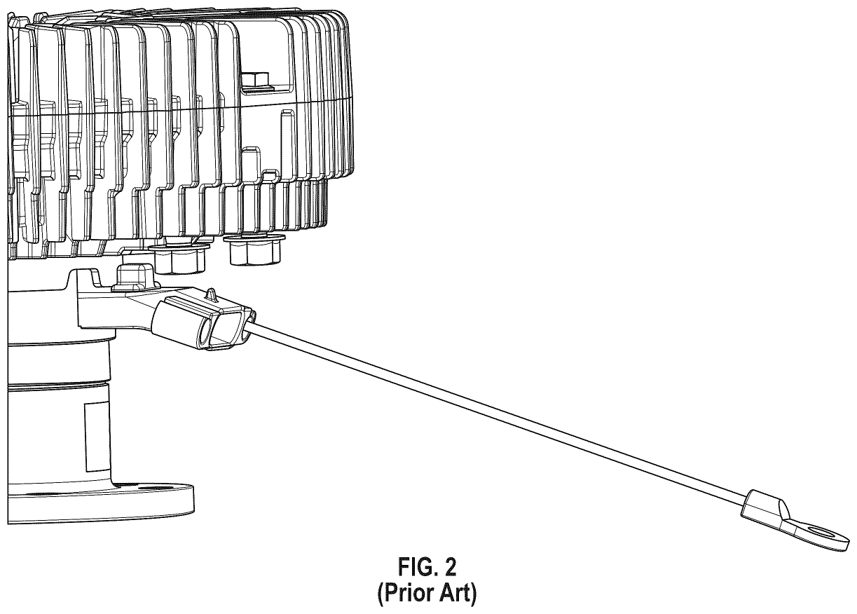

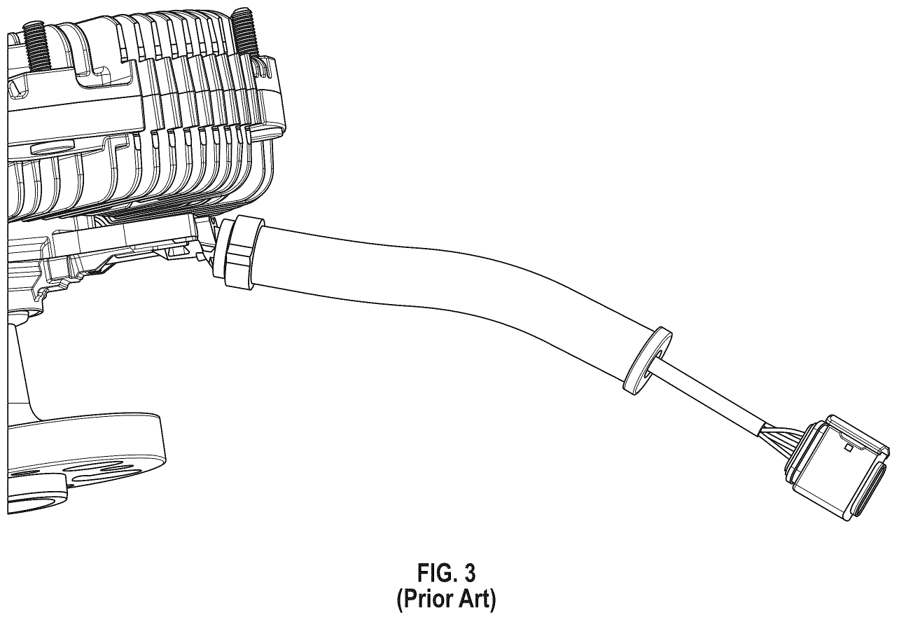

While the above-identified figures set forth one or more embodiments of the present invention, other embodiments are also contemplated as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps, and/or components not specifically shown in the drawings.

### DETAILED DESCRIPTION OF ILLUSTRATIVE EMBODIMENTS

Disclosed embodiments of the present invention provide an electromagnetic coil assembly, electrical and anti-rotation tether connection, an associated viscous clutch assembly, and associated methods of making and using the same. More particularly, disclosed embodiments can include an electromagnetic coil assembly, a sensor provided with the electromagnetic coil assembly, a coil housing cutout aligned with the sensor, a coil-side electrical connector, an electrical cable with a cable-side electrical connector, one or more mechanical fasteners (e.g., screws or bolts) mechanically securing the cable-side electrical connector to the electromagnetic coil assembly, and/or an anti-rotation tether mechanically secured to the cable-side electrical connector. In some embodiments, the electromagnet coil and the sensor can be provided together as a single unit, which can have a common covering at or along an exterior of that unit. The viscous clutch assembly can be usable as a fan drive, such as for a vehicular cooling fan, in some embodiments. Various additional features and benefits of the present invention will be appreciated by persons of ordinary skill in the art in view of the entirety of the present disclosure, including the accompanying drawings.

This application claims priority to U.S. provisional application Ser. No. 63/509,106, filed Jun. 20, 2023, which is hereby incorporated by reference in its entirety.

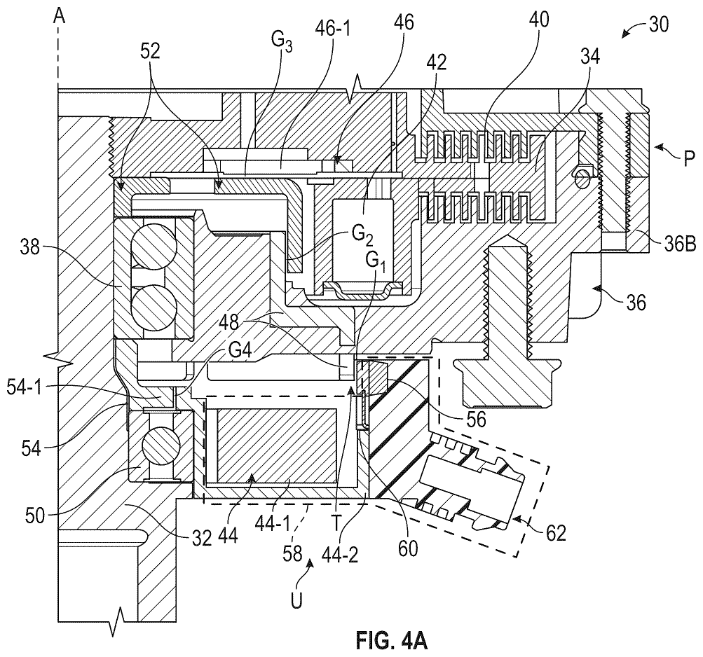

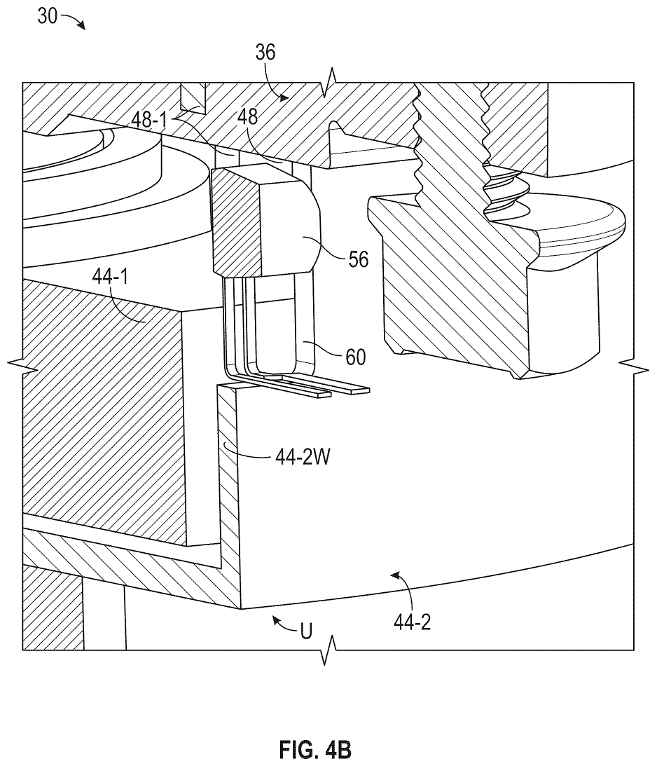

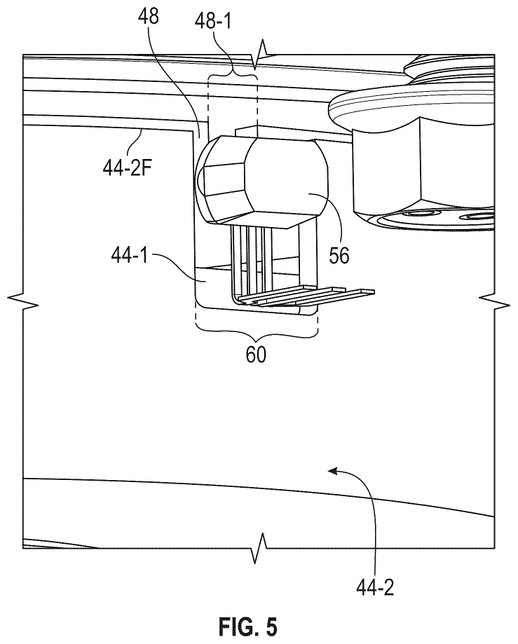

FIGS. 4A to 9 illustrate a viscous clutch assembly 30 with an electrical and anti-rotation assembly C according to an embodiment of the present invention.

In some embodiments, the viscous clutch assembly 30 can include a center shaft 32 (for example, a “live” or rotatable center shaft) and a clutch pack P having a general configuration and method of operation similar to an embodiment disclosed in U.S. Pat. No. 10,941,819 B2 (the U.S. national phase entry of WO2018/004833A1), for example. In the illustrated embodiment as shown in FIG. 4A, the viscous clutch assembly 30 includes the clutch pack P having a rotor 34 rotationally fixed to the center shaft 32, a housing 36 rotatably supported on the center shaft 32 on bearings 38, a working chamber 40 located between and exposed to both the rotor 34 and the housing 36, a reservoir 42 (which can be carried by and rotate at all times with the rotor 34, in some embodiments), a return bore (not shown) to return shear fluid from the working chamber 40 to the reservoir 42, an electromagnetic coil 44, a valve assembly 46, and a magnetic flux circuit that links the electromagnetic coil 44 and the valve assembly 46 and passes through a flux guide insert 48 in the housing. An axis of rotation A is defined by the clutch pack P that extends along and is aligned with the center shaft 32.

As shown in the illustrated embodiment, the electromagnetic coil 44 is rotatably supported on the center shaft 32 on a set of bearings 50 located outside the housing 36 at an external, rear side of the viscous clutch assembly 30. The electromagnetic coil 44 includes at least one winding 44-1 located at least partially in a coil housing 44-2, and with the at least one winding 44-1 forming multiple turns within the coil housing 44-2. In the drawings the winding(s) 44-1 is/are shown only schematically, for simplicity. The winding(s) 44-1 can optionally be wound on a bobbin (not shown) positioned at least partially within the coil housing 44-2. The coil housing 44-2 is made of a magnetic flux-conductive material (for example, ferromagnetic material) to conduct magnetic flux generated when the winding(s) 44-1 are energized. In the illustrated embodiment, the coil housing 44-2 has an annular cup shape with an axially open face at a front side.

In some embodiments, the valve assembly 46 can be configured similarly to that disclosed in PCT International Application Pub. No. WO2023/183118A1, or alternatively configured similarly to that disclosed in U.S. Pat. No. 8,881,881 B2 (the U.S. national phase entry of WO2012/024497A2), or alternatively can have a different configuration as desired for particular applications.

During operation, the electromagnetic coil 44 can be selectively energized (through selective supply of electrical power to the winding(s) 44-1) to control operation of the valve assembly 46 to regulate a volume of a shear fluid (such as silicone oil) present in the working chamber 40 to govern a degree of fluid friction engagement between the rotor 34 and housing 36 and, in turn, control an output speed of the viscous clutch assembly 30 relative to an input speed whenever there is a torque input to the viscous clutch assembly 30. In brief, in the illustrated embodiment, magnetic flux from the electromagnetic coil 44 can move (e.g., axially pivot) an armature 46-1 of the valve assembly 46, which in turn can move (e.g., concurrently pivot by pressing against) a spring-biased valve element (e.g., reed valve) of the valve assembly 46 to cover and uncover an outlet bore of the reservoir 42 (e.g., in a “fail on” configuration). The general operation of electromagnetically-controlled valves in viscous clutches is well known.

A pump mechanism (not shown) can be utilized to passively pump the shear fluid from the working chamber 40 to the reservoir 42 through the return bore during operation of the viscous clutch assembly 30 in a known manner.

In the illustrated embodiment, the flux guide insert 48 is made of a magnetic flux-conductive material and is embedded in a base portion 36B of the housing 36 at a rear side. The flux guide insert 48 is rotationally fixed to the housing 36 and rotates at the same speed as the housing 36 at all times. The flux guide insert 48 can protrude or be exposed from material of the base portion 36B at opposite front and/or rear sides. In the illustrated embodiment, a rear end of the flux guide insert 48 is located in close proximity to part of the coil housing 44-2 with a small radial gap (first air gap G1) between them. The flux guide insert 48 allows for the transmission of magnetic flux through material of the housing 36, which is otherwise typically made of a material like aluminum that does not efficiently transmit magnetic flux.

One or more additional flux guide(s) 52 are also provided in the illustrated embodiment. Those additional flux guide(s) 52 can be stand-alone flux guide(s), flux guide insert(s), and/or flux-conductive portion(s) of the rotor 34. In some embodiments, the one or more additional flux guide(s) 52 can be an assembly of discrete elements that rotate together and either are in contact with each other and/or separated by small gaps to allow for magnetic flux transmission through them. As shown in FIG. 4A, the additional flux guide(s) 52 are located at or near a rear side of the rotor 34, and extend from the center shaft 32 radially outward and also extend axially rearward so as to be located in close proximity to a front end of the flux guide insert 48 in the housing 36 with a small radial gap (second air gap G2) between them. The armature 46-1 of the valve assembly 46 is located in close proximity to a part of the one or more additional flux guide(s) 52, such that magnetic flux present in the one or more additional flux guide(s) 52 can magnetically act upon the armature 46-1.

The magnetic flux circuit of the viscous clutch assembly 30 that transmits magnetic flux to facilitate actuation of the valve assembly 46 can have the following configuration, as shown in the illustrated embodiment. The flux circuit extends from the coil housing 44-2 of the electromagnetic coil 44 to the flux guide insert in the housing 36 across the first air gap G1. Next, the flux circuit extends from the flux guide insert 48 to the one or more additional flux guide(s) 52 across the second air gap G2. Then the flux circuit extends from the one or more additional flux guide(s) 52 to the armature 46-1 of the valve assembly 46. The armature 46-1, which is movable in response to an applied magnetic field, can bridge a variable distance of a generally axial air gap G3 that can reduce to zero when the electromagnetic coil 44 is energized. The flux circuit then extends from the armature 46-1 to another part of the one or more additional flux guide(s) 52 and then to the center shaft 32, which can be made of a magnetic flux-conductive material (such as a ferromagnetic material). Lastly, the flux circuit extends from the center shaft 32 back to the coil housing 44-2 of electromagnetic coil 44 across a final air gap G4, which can be arranged radially. A spacer 54 made of a magnetic (e.g., ferromagnetic) material can optionally be provided along the center shaft 32 adjacent to the bearings 38 and/or the bearings 50 (for example, abutting and separating races of the bearings 38 and 50) to help establish a desired flux path of the flux circuit. As shown, the spacer 54 has a flange 54-1 that extends radially outwardly in close proximity to the coil housing 44-2, and the final air gap G4 is located between the flange 54-1 of the spacer 54 and the coil housing 44-2. In the illustrated embodiment, the flux circuit is located mostly or entirely to a rear side of the rotor 34, and is relatively compact, which helps reduce flux density requirements and permits use of the electromagnetic coil 44 to be relatively smaller and less massive.

In some embodiments, a sensor 56 (for example, a Hall effect sensor) is carried with the electromagnetic coil 44 as a single electromagnetic coil assembly U, such as with the electromagnetic coil 44 and the sensor 56 being overmolded (for example, via injection molding of a polymer material) and/or potted with a common covering 58 to form the electromagnetic coil assembly U as an integrated electromagnetic coil/sensor unit. Although not specifically shown in the drawings, additional circuitry (such as one or more circuit boards) can be included within the common covering 58 and electrically connected to the sensor 56, the winding(s) 44-1, and/or other components. In FIG. 4A, the common covering 58 is shown only schematically as a border in a dashed line. The common covering 58 is generally made of a substantially non-electrically conductive material. In the illustrated embodiment, the sensor 56 is a Hall effect sensor that is aligned with (that is, axially overlaps with) the rear end portion of the flux guide insert 48 (for example, with the sensor 56 at or near a front end of the electromagnetic coil assembly (or unit) U, with the sensor 56 located at or near an outer diameter of the coil housing 44-2, and with the sensor 56 operably facing radially inward toward the flux guide insert 48). The flux guide insert 48 has a target 48-1, which can be a circumferential interruption such as a notch, slit, hole, opening, or the like, that rotates with the flux guide insert 48 and the housing 26 at the same speed. During operation, the sensor 56 can sense a rotational speed of the housing 36 relative to the rotationally fixed electromagnetic coil assembly U. In this way, the flux guide insert 48 also functions as (or integrally provides) the target 48-1, which can eliminate the need for an additional or dedicated sensor target wheel in some embodiments, and which does not interfere with operation of the flux circuit, the valve assembly 46, or other clutch components. Moreover, the radial arrangement of the sensor 56 and flux guide insert 48 (and the target 48-1) helps to accommodate manufacturing and operational tolerance variations (e.g., axial misalignment) without materially decreasing sensing accuracy.

The electromagnetic coil 44 (specifically the coil housing 44-2) can transmit magnetic flux to the flux guide insert 48 in an overlapping area (an axially overlapping area as shown in the illustrated embodiment). Normally, in this environment, a Hall effect sensor would not work effectively because the magnetic field strength from the electromagnetic coil 44 is too high. Therefore, in the illustrated embodiment (see FIGS. 4A, 4B, 5, 8 and 9), the coil housing 44-2 is cut out around the Hall effect sensor 56 (which can be located at a discrete circumferential location) to separate and at least partially isolate a magnetic field and flux of the electromagnetic coil 44 from the Hall effect sensor 56. In this way, the presence of a cutout 60 that interrupts the magnetic flux-conducting metallic material of the coil housing 44-2, and the coil housing 44-2 is circumferentially discontinuous adjacent to the Hall effect sensor 56. The Hall effect sensor 56 is aligned with the cutout 60. In some embodiments, such as in the illustrated embodiment, at least a portion of the Hall effect sensor 56 is arranged within the cutout 60, that is, with at least a portion of the sensor 56 extending into the cutout 60 and overlapping with material forming a wall 44-2W of the coil housing 44-2 (for instance, radially overlapping a thickness of the wall 44-2W through which the cutout 60 extends). In alternate embodiments, the Hall effect sensor 56 can be adjacent to but not within the cutout 60, such that the sensor 56 senses through the cutout 60. Suitable positioning of the sensor 56 will depend on a maximum nominal air gap across which Hall effect sensing can be accomplished for a given sensor device and a thickness of the wall 44-2W of the coil housing 44-2 adjacent to the cutout 60. The thickness of the wall 44-2W adjacent to the cutout 60 must be sufficiently less than the maximum nominal air gap between the target 48-1 and the sensor 56 across which Hall effect sensing can be accomplished, in order to allow for sensing while preserving an air gap between the target 48-1 and the sensor 56 that permits relative rotation without interference or contact. The cutout 60 can have a substantially rectangular shape, or, alternatively, a different shape in further embodiments. In the illustrated embodiment, the wall 44-2W in which the cutout 60 is located extends substantially axially and is located at an outer diameter of the coil housing 44-2. In some embodiments, the cutout 60 extends to a forward edge 44-2F of the wall 44-2W of the coil housing 44-2, such that a forward side of the cutout 60 is unbounded by the magnetic flux-conducting metallic material of the coil housing 44-2. The forward edge 44-2F of the wall 44-2W of the coil housing 44-2 can extend axially forward of the multiple turns of the at least one winding 44-1 within the coil housing 44-2, in some embodiments. Moreover, in some embodiments, a forward part of the cutout 60 can be located forward of the multiple turns of the winding(s) 44-1, and wherein a rear part of the cutout overlaps with at least a portion of the multiple turns of the winding(s) 44-1 within the coil housing 44-2, such that a target space T is located radially inward of the wall 44-2W and axially forward of the multiple turns of the winding(s) 44-1.

In alternate embodiments, the sensor 56 (and the cutout 60) could be omitted entirely.

The electromagnetic coil 44 in the illustrated embodiment (see FIGS. 4A and 6A to 9) further includes a coil-side connector 62 that can be used to create an electrical and anti-rotation connection assembly C. After the viscous clutch assembly 30 is manufactured, such as when later installing the viscous clutch assembly 30 in a vehicle or other desired installation location, an electrical cable 70 with a cable-side connector 72 is attached to the electromagnetic coil 44 at the coil-side connector 62 and the electromagnetic coil assembly (with or without the sensor 56 in various embodiments) is tethered to a rotationally fixed location with an anti-rotation bracket (ARB) or anti-rotation tether 74. The electrical cable 70 is located external of the clutch pack P. The electrical cable 70 can also be electrically connected to an external device (not shown) that can supply electrical power, control operation of the electromagnetic coil 44 (e.g., establish a pulse width modulation duty cycle for electrical power supplied to the winding(s) 44-1 thereof), and/or receive sensor signals (e.g., from the sensor 56). For instance, the external device can be a Di+® controller available from Horton, Inc. (Roseville, MN, USA), or an engine or vehicle controller. In the accompanying drawings, for simplicity, sectional views do not show interior details of the electrical cable 70, such as individual wire(s), electrical insulator(s), etc.

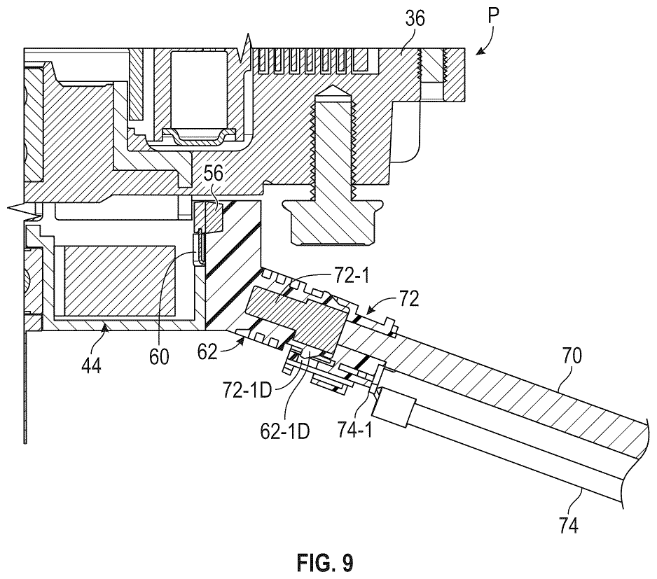

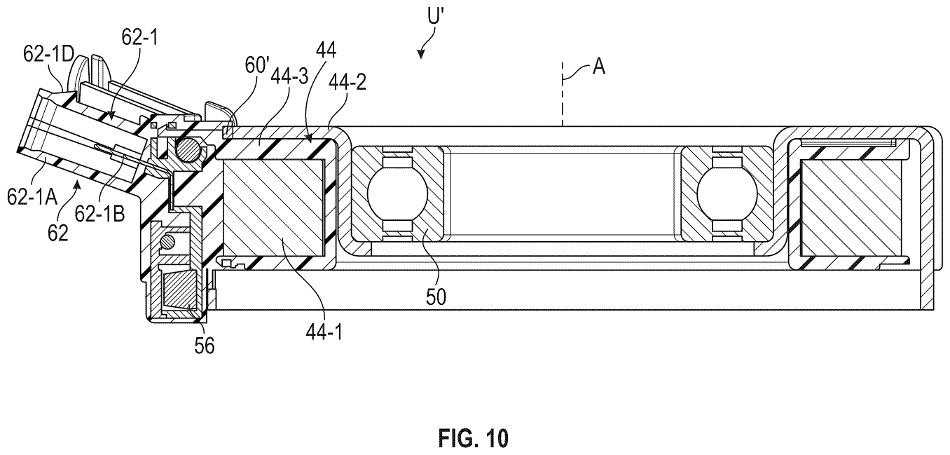

In the illustrated embodiment, the coil-side and cable-side connectors 62 and 72 each have respective inner electrical conductor portions 62-1 and 72-1 that can mate with each other to from one or more discrete electrical connections. The inner electrical conductor portion 62-1 of the coil-side connector 62 is electrically connected to winding(s) 44-1 of the electromagnetic coil 44, the sensor 56, and/or other coil-side components (for simplicity, in FIGS. 4A and 7-9 the inner electrical conductor portions 62-1 and 72-1 are shown somewhat schematically, without all electrical conductors specifically depicted, for instance, but see also the embodiment FIG. 10 which shows some additional detail). The inner electrical conductor portion 72-1 of the cable-side connector 72 is electrically connected to wire(s) of the electrical cable 70 (of a desired length for a particular application), which can, for instance, further be electrically connected to user/customer-specified connector (not shown) at an opposite end. The inner electrical conductor portions 62-1 and 72-1 form a seal when engaged together, to help limit or prevent incursion of liquid, dust, and/or other foreign materials past the coil-side connector 62 and into an interior of the electromagnetic coil assembly U. Moreover, engagement of the inner electrical conductor portions 62-1 and 72-1 can include mechanical engagement or mating components that help provide a structural mechanical connection that helps provide anti-rotation fixation. For example, in the illustrated embodiment, the mechanically engaging mating components associated with the inner electrical conductor portions 62-1 and 72-1 are mechanically interlocking plug and socket components 62-1A and 72-1A located adjacent to or surrounding electrical components 62-1B (the electrical component of the cable-side inner electrical conductor portion 72-1 is not specifically shown), such as pins, pads, sockets, etc. The plug and socket components 62-1A and 72-1A can each have non-circular shapes to provide anti-rotation functionality, and further can have one or more mateable detent-like engagement prongs or arms and detent apertures 62-1D and 72-1D (see FIG. 9). The electrical connectors at the opposite ends of the electrical cable 70 can be different and of non-compatible types in some embodiments, that is, the cable-side electrical connector 72 can have a different configuration than one (not shown) used at the opposite end of the electrical cable 70.

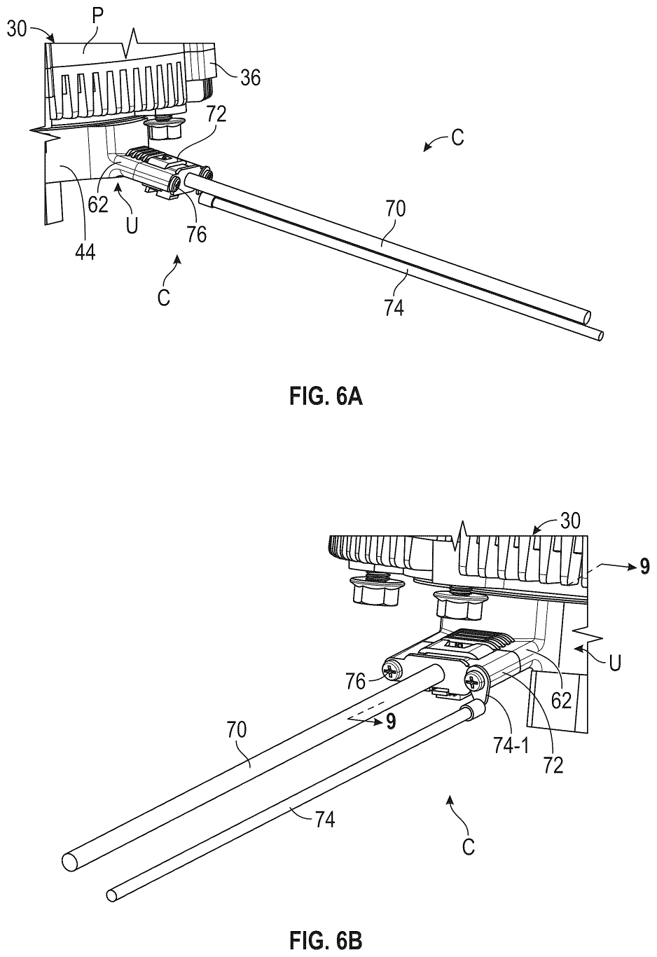

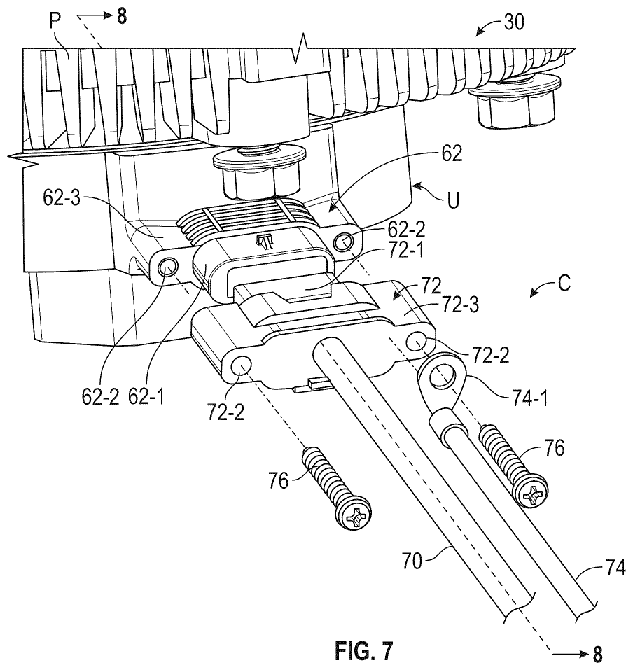

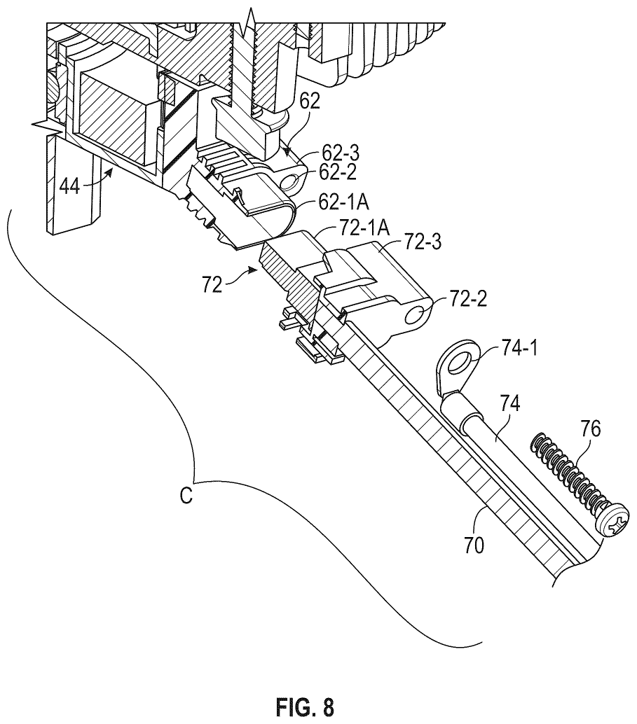

Further, in the illustrated embodiment (see, e.g., FIGS. 7 and 8), the coil-side and cable-side connectors 62 and 72 each have one or more fastener openings 62-2 and 72-2, with the illustrated embodiment showing two such fastener openings 62-2 and 72-2, one on each side of the respective inner electrical conduction portions 62-1 and 72-1 in a respective body portion 62-3 and 72-3. The fastener opening(s) 62-2 in the coil-side connector 62 can be threaded, while the fastener openings 72-2 in the cable-side connector 72 can optionally be unthreaded, in some embodiments. Mechanical fastener(s) 76, such as screws, bolts, or the like, can be inserted through the cable-side fastener opening(s) 72-2 and engaged with the coil-side connector 62 at the coil-side connector opening(s) 62-2, to mechanically secure the cable-side connector 72 and associated electrical cable 70 to the coil-side connector 62 at locations spaced from or otherwise distinct and separate from the mating inner electrical conductor portions 62-1 and 72-1. For example, threaded screws or bolts used as the mechanical fastener(s) 76 can be threadably engaged with threaded openings 62-2 in the coil-side connector 62 and heads of those threaded screws or bolts can apply a compressive retaining force to the cable-side connector 72 toward or otherwise in the direction of the coil-side connector 62 (see, e.g., FIGS. 6A and 6B). Thus, in the illustrated embodiment, electrical connection(s) (and environmental seal(s)) are made separately from mechanical connection(s) made by the mechanical fastener(s) 76 at the openings 62-2 and 72-2, which can be purely mechanical in nature without transmitting any electrical current or signals. In further embodiments, non-removable fasteners could be utilized as the mechanical fastener(s) 76, such as barbed connectors (which could optionally be integrated into the cable-side connector 72, for instance) that engage the openings 62-2 of the coil-side connector 62 but which cannot be removed or disengaged non-destructively. Although the fastener openings 62-2 have been described as being part of the coil-side connector 62, in still further alternate embodiments, those fastener openings 62-2 could be part of another distinct component of the electromagnetic coil assembly U.

Additionally, the connection assembly includes an anti-rotation tether (or ARB tether) 74. The anti-rotation tether 74 can be a structural cable (e.g., a flexible wire rope), rod, bracket, or the like capable of carrying a mechanical load to rotationally fix the electromagnetic coil assembly U (including the sensor 56, if present) to a rotationally fixed external mounting location, such as a rotationally fixed engine compartment location, frame, engine block, etc. In the illustrated embodiment the anti-rotation tether 74 is a structural cable with eyelets 74-1 for fastener attachment at cither end. Generally, the anti-rotation tether 74 is separate from electrical power and/or signal conducting components (e.g., separate and distinct from the electrical cable 70) and serves a purely mechanical function. Although in some embodiments, the anti-rotation tether 74 could potentially help provide electrical grounding. The anti-rotation tether 74 can rotationally secure or tether the cable-side connector 72, which can in turn rotationally secure and fix the coil-side connector 62 and the rest of the electromagnetic coil assembly U (including the sensor 56, when present).

In the illustrated embodiment, the anti-rotation tether 74 is anchored to the electromagnetic coil 44 at the coil-side connector 62 via one or more of the mechanical fastener(s) 76 engaged at the coil-side connector opening(s) 62-2. For example, the eyelet 74-1 at an end of the anti-rotation tether 74 in the illustrated embodiment is directly secured against the cable-side connector 72, at an opposite side of the cable-side connector 72 from the coil-side connector 62, with one of the mechanical fastener(s) 76. A washer or the like could optionally be provided between the eyelet 74-1 of the anti-rotation tether 74 and the cable-side connector 72 while still having such a directly engaged connection. In further embodiments, the eyelet 74-1 of the anti-rotation tether 74 could be secured by one of the mechanical fastener(s) 76 in between the coil-side and cable-side connectors 62 and 72, in a sandwiched stack-up, with the anti-rotation tether 74 still directly secured to the cable-side connector 72 with the fastener 76. In still further embodiments, the anti-rotation tether 74 can be secured to the cable-side connector 72 with an additional dedicated tether fastener.

FIG. 10 is a sectional view of a portion of another embodiment of an electromagnetic coil assembly U′. The components of the electromagnetic coil assembly U′ are generally the same as those described above with respect to electromagnetic coil assembly U. However, the electromagnetic coil assembly U′ further includes a bobbin 44-3 in which turns of the winding(s) 44-1 are positioned. In the illustrated embodiment, the bobbin 44-3 has a generally open face at an outer diameter portion, such as with a winding-holding portion of the bobbin 44-3 having a substantially “U” shape in section that is open facing radially outward, while the coil housing 44-2 has a generally cup shape that is open facing axially forward. Moreover, in the embodiment of FIG. 10, a cutout 60′ is larger than the cutout 60. While the cutout 60 was only slightly larger than a sensing portion of the sensor 56, the cutout 60′ in the coil housing 44-2 is larger. More particularly, the cutout 60′ can be configured as a slot that extends axially substantially or completely along an entire axial length of the wall 44-2W at an outer diameter portion of the coil housing 44-2 (and pass entirely through a thickness of the wall 44-2W to circumferentially interrupt material of the coil housing 44-2), and can also extend radially along a radially-extending wall portion of the coil housing 44-2.

As will be recognized from the foregoing description, and the accompanying drawings, disclosed embodiments can include mechanically fastening together with mechanical fasteners (e.g., screws or bolts) the electromagnetic coil assembly U or U′ and the mating cable-side connector 72 to make a single-piece unit, and attaching the anti-rotation (or ARB) tether 74 directly to the electrical cable (or “jumper”) 70 and an associated connector 72 instead of directly to the electromagnetic coil 44.

Disclosed embodiments of a viscous clutch assembly 30, and associated electrical and anti-rotation connection assembly C, allow for the manufacture of “basic” or semi-universal clutch packs P with the required coil voltage specified, while permitting the later attachment of user/customer-specific electrical connector(s) 62 and/or 72, electrical cable 70 (at a desired length), and anti-rotation tether 74 (at a desired length) to make an end part number—that is, a final part number for the combination of the specific-voltage “basic” clutch plus an application-specific tether 74, electrical cable 70, and connector assembly (e.g., connectors 62 and 72). This significantly reduces the number of electromagnetic coil part numbers and simplifies manufacturing, while allowing different (first, second, etc.) electrical connectors that have different configurations and are incompatible with each other (e.g., not able to matingly connect with the same mating connectors) to be used with the same “basic” or semi-universal clutch pack P. This helps facilitate modularity in clutch assembly and fabrication. Disclosed embodiments also help provide a relatively low cost, reliable, accurate (for speed sensing), modular/customizable, field-serviceable, and long lasting/wear resistant overall clutch implementation. Other features and benefits will be appreciated by persons of ordinary skill in the art in view of the entirety of the present disclosure, including the accompanying figures.

### Discussion of Possible Embodiments

An electromagnetic coil assembly for use with a viscous clutch can include: a coil housing made of a magnetic flux-conducting metallic material and having an annular cup shape; a winding that forms multiple turns within the coil housing; a cutout in the coil housing that interrupts the magnetic flux-conducting metallic material; and a Hall effect sensor aligned with the cutout.

The electromagnetic coil assembly of the preceding paragraph can optionally include, additionally and/or alternatively, any one or more of the following features, configurations, and/or additional components:
the Hall effect sensor can be located at or near an outer diameter of the coil housing and/or can operably face inward;
at least a portion of the Hall effect sensor can be arranged within the cutout;
the cutout can extend to a forward edge of a wall of the coil housing, such that a forward side of the cutout is unbounded by the magnetic flux-conducting metallic material of the coil housing (and one or more, or all, other sides of the cutout can be bounded by the magnetic flux-conducting metallic material of the coil housing);
the wall can extend substantially axially and/or can be located at an outer diameter of the coil housing;
the forward edge of the wall of the coil housing can extend axially forward of the multiple turns of the winding within the coil housing;
a forward part of the cutout can be located forward of the multiple turns of the winding, and a rear part of the cutout can overlap with at least a portion of the multiple turns of the winding, such that a target space is located radially inward of a wall of the coil housing at an outer diameter of the electromagnetic coil and axially forward of the multiple turns of the winding;
the cutout can have a substantially rectangular shape;
the coil housing can have an annular cup shape with an axially open face at a front side;
the coil housing can include a wall that is located at an outer diameter of the coil housing, and the cutout can be located in the wall;
a covering consisting essentially of a non-metallic material that covers the multiple turns of the winding within the coil housing and further covers a portion of the coil housing, and the Hall effect sensor can at least partially protrude outside the covering; and/or
an electrical connector located adjacent to the Hall effect sensor, the electrical connector configured to be matingly engageable to another connector to form one or more external electrical connections, with the electrical connector being electrically connected to the winding and electrically connected to the Hall effect sensor.

A viscous clutch assembly can include: a rotor; a housing rotatable relative to the rotor; a working chamber located between and exposed to both the rotor and the housing; a reservoir to hold a supply of a shear fluid; a valve assembly that is magnetically controllable to regulate flow of the shear fluid between the reservoir and the working chamber; and an electromagnetic coil assembly. The valve assembly and the electromagnetic coil assembly are operably connected by way of a flux circuit, and the electromagnetic coil assembly is rotationally stationary. The electromagnetic coil assembly can include a coil housing made of a magnetic flux-conducting metallic material and having an annular cup shape; a winding that forms multiple turns within the coil housing; a cutout in the coil housing that interrupts the magnetic flux-conducting metallic material; and a Hall effect sensor aligned with the cutout.

The viscous clutch assembly of the preceding paragraph can optionally include, additionally and/or alternatively, any one or more of the following features, configurations, and/or additional components:
a flux guide that passes through a portion of the housing, the flux guide including a rear portion having a target, with the rear portion is positioned adjacent to the Hall effect sensor, separated by a gap, such that the target is rotatable through a sensing region of the Hall effect sensor.

A viscous clutch assembly can include: a rotor; a housing rotatable relative to the rotor; a working chamber located between and exposed to both the rotor and the housing; a reservoir to hold a supply of a shear fluid; a valve assembly that is magnetically controllable to regulate flow of the shear fluid between the reservoir and the working chamber; and an electromagnetic coil assembly. The valve assembly and the electromagnetic coil assembly are operably connected by way of a flux circuit. The electromagnetic coil assembly can include: a coil housing made of a magnetic flux-conducting metallic material; a winding that forms multiple turns within the coil housing; and an electrical connector configured to be matingly engageable to another connector to form one or more external electrical connections. The electrical connector can include: an inner electrical conductor portion that provides one or more discrete electrical connections, at least one of which is electrically connected to the winding, and the inner electrical conductor portion can be configured to form a seal with another connector upon engagement to another connector; and one or more fastener openings each located alongside the inner electrical conductor portion, the electromagnetic coil assembly being rotationally stationary. At least one of the one or more fastener openings can be configured establish an anti-rotation tether point for the electromagnetic coil assembly.

The viscous clutch assembly of the preceding paragraph can optionally include, additionally and/or alternatively, any one or more of the following features, configurations, and/or additional components:
the electrical connector can include a mechanical engagement component on or along the inner electrical connection configured to provide a structural mechanical connection to another connector upon engagement thereto;
the mechanical engagement component can be (a) a non-circular plug or socket component, (b) one or more detent prongs or detent apertures, and (c) combinations thereof;
the electromagnetic coil assembly can include: a cutout in the coil housing that interrupts the magnetic flux-conducting metallic material;
a Hall effect sensor can be aligned with the cutout, and at least one of the one or more discrete electrical connections of the inner electrical conductor portion of the electrical connector can be electrically connected to the Hall effect sensor;
a flux guide that passes through a portion of the housing, the flux guide including a rear portion having a target, the rear portion positioned adjacent to the Hall effect sensor, separated by a gap, such that the target is rotatable through a sensing region of the Hall effect sensor;
the rear portion of the flux guide having the target can be arranged to be rotatable in a target space located radially inward of a wall of the coil housing and axially forward of the multiple turns of the winding within the coil housing;
the Hall effect sensor can be located at or near an outer diameter of the coil housing and/or can operably face inward toward the target space;
the cutout can be configured as a notch that extends to a forward edge of a wall of the coil housing, such that a forward side of the cutout is unbounded by the magnetic flux-conducting metallic material of the coil housing (and one or more, or all, other sides of the cutout can be bounded by the magnetic flux-conducting metallic material of the coil housing);
at least a portion of the Hall effect sensor can extend into the cutout;
a covering consisting essentially of a non-metallic material that covers the multiple turns of the winding within the coil housing, covers at least a portion of the electrical connector, and further covers a portion of the coil housing;
the Hall effect sensor can at least partially protrude outside the covering;
the covering can be made of a polymer material;
the covering can encapsulate at least the electromagnetic coil assembly and the electrical connector together as a single unit;
the coil housing can have an annular cup shape with an axially open face at a front side;
a center shaft that is rotatable;
a set of bearings, wherein the electromagnetic coil assembly is supported on the center shaft by the set of bearings; and/or
the electromagnetic coil assembly can be located adjacent the housing at an exterior rear side of the viscous clutch assembly.

A method of assembling a viscous clutch assembly: providing a clutch pack that includes a housing, a rotor, a reservoir, and a valve assembly; securing an electromagnetic coil assembly to the clutch pack, the electromagnetic coil assembly including an electromagnetic coil and a coil-side connector electrically connected to a winding of the electromagnetic coil, with the clutch pack and the electromagnetic coil assembly both being supported on a center shaft; electrically connecting a cable-side connector to the coil-side connector, such that the electromagnetic coil is electrically connected to the cable-side connector, and with the cable-side connector electrically connected to an electrical cable positioned external to the clutch pack; mechanically securing the cable-side connector and the coil-side connector together; and connecting an anti-rotation tether to the cable-side connector and the coil-side connector with a mechanical fastener, the anti-rotation tether being directly connected to the cable-side connector with the mechanical fastener, and with the cable-side connector, the coil-side connector, and the anti-rotation tether secured together with the mechanical fastener at a location spaced from respective inner electrical conductor portions of the cable-side connector and the coil-side connector that electrically connect the cable-side connector to the coil-side connector.

The method of the preceding paragraph can optionally include, additionally and/or alternatively, any one or more of the following features, configurations, and/or additional steps:
the mechanical fastener can be a threaded fastener that is threadably engaged with the coil-side connector and that further passes through an opening in the cable-side connector and an eyelet of the anti-rotation tether to both mechanically secure the cable-side connector and the coil-side connector together and directly connect the anti-rotation tether to the cable-side connector;
encasing at least portions of the electromagnetic coil and the coil-side connector in a common covering to provide an integrated unit;
the common covering can cover turns of a winding positioned within a coil housing of the electromagnetic coil;
providing a sensor configured to sense rotational speed;
the step of encasing at least portions of the electromagnetic coil and the coil-side connector in the common covering can further include encasing at least a portion of the sensor with the common covering;
arranging the sensor at a cutout in a coil housing of the electromagnetic coil;
the sensor can be a Hall effect sensor;
the sensor can be arranged to sense rotation of a target carried by the housing of the clutch pack; and/or
creating a seal between the cable-side connector and the coil-side connector.

A method of making viscous clutch assemblies can include: providing a first clutch pack that includes a first housing, a first rotor, a first reservoir, and a first valve assembly; providing a second clutch pack that includes a second housing, a second rotor, a second reservoir, and a second valve assembly, with the first clutch pack and the second clutch pack having substantially or exactly the same configuration; securing a first electromagnetic coil assembly to the first clutch pack, the first electromagnetic coil assembly including a first electromagnetic coil and a first coil-side connector electrically connected to the first electromagnetic coil, the first clutch pack and the first electromagnetic coil assembly both being supported on a first center shaft; securing a second electromagnetic coil assembly to the second clutch pack, the second electromagnetic coil assembly including a second electromagnetic coil and a second coil-side connector electrically connected to the second electromagnetic coil, the second clutch pack and the second electromagnetic coil assembly both being supported on a second center shaft, and the second coil-side connector having a different configuration than the first coil-side connector; electrically connecting a first cable-side connector to the first coil-side connector, such that the first electromagnetic coil is electrically connected to the first cable-side connector, and with the first cable-side connector being electrically connected to a first electrical cable positioned external to the first clutch pack, the first electrical cable having a first length; electrically connecting a second cable-side connector to the second coil-side connector, such that the second electromagnetic coil is electrically connected to the second cable-side connector, the second cable-side connector being electrically connected to a second electrical cable positioned external to the second clutch pack, the second electrical cable having a second length that is different from the first length of the first electrical cable, and the second cable-side connector having a different configuration than the first cable-side connector such that the first coil-side connector is incompatible with the second cable-side connector and the second coil-side connector is incompatible with the first cable-side connector; connecting a first anti-rotation tether to the first cable-side connector and the first coil-side connector with a first mechanical fastener, the first anti-rotation tether being directly connected to the first cable-side connector with the first mechanical fastener; and connecting a second anti-rotation tether to the second cable-side connector and the second coil-side connector with a second mechanical fastener, the second anti-rotation tether being directly connected to the second cable-side connector with the second mechanical fastener.

The method of the preceding paragraph can optionally include, additionally and/or alternatively, any one or more of the following features, configurations, and/or additional steps:

The method can provide for modular fabrication of clutch assemblies with different overall configurations utilizing a pool of certain common components;
the first and second mechanical fasteners can each be a threaded fastener that is threadably engaged with the respective first or second coil-side connector and that further passes through a respective opening in the first or second cable-side connector and a respective eyelet of the first or second anti-rotation tether;
encasing at least portions of the first electromagnetic coil and the first coil-side connector in a first common covering to provide a first integrated unit;
encasing at least portions of the second electromagnetic coil and the second coil-side connector in a second common covering to provide a second integrated unit;
providing a first sensor configured to sense rotational speed of the first housing relative to the first electromagnetic coil assembly;
the step of encasing at least portions of the first electromagnetic coil and the first coil-side connector in the first common covering can further include encasing at least a portion of the first sensor with the first common covering;
arranging the first sensor at a cutout in a first coil housing of the first electromagnetic coil;
the first sensor can be a Hall effect sensor; and/or
the first sensor can be arranged to face a first target space through which a first target carried by the first housing of the first clutch pack can rotate.

### Summation

Any relative terms or terms of degree used herein, such as “substantially”, “essentially”, “generally”, “approximately”, and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, transient alignment or shape variations induced by thermal, rotational or vibrational operational conditions, transitory signal fluctuations, and the like. Moreover, any relative terms or terms of degree used herein should be interpreted to encompass a range that expressly includes the designated quality, characteristic, parameter, or value, without variation, as if no qualifying relative term or term of degree were utilized in the given disclosure or recitation.

The word “comprise”, or variations such as “comprises” or “comprising” are used in an open-ended manner herein and should be interpreted to refer to the inclusion of a stated element, feature, or step, or group of elements, features, or steps, but not the exclusion of any other element, feature, or step, or group of elements, features, or steps. Unless further expressly qualified, use of the word “comprise” or variations thereof does not, alone, exclude the present additional, unrecited elements, steps, or groups of elements or steps. Additionally, unless further expressly qualified, the words “a” and “an” as used herein refer to one or more and do not limit the identified element, feature, step, or the like to one and only one. However, use of the words “a” and “an” herein should be interpreted in accordance with and subject to any applicable further limits expressly stated in the context of any particular instance of usage, without extending such context-specific limits to all other uses generally.

Although the present invention has been described with reference to preferred embodiments, workers skilled in the art will recognize that changes may be made in form and detail without departing from the spirit and scope of the invention. For example, features, steps, and the like described with respect to one embodiment can generally be utilized with another other embodiment unless otherwise indicated.

1. An electromagnetic coil assembly for use with a viscous clutch, the electromagnetic coil assembly comprising:
a coil housing made of a magnetic flux-conducting metallic material and having an annular cup shape;
a winding that forms multiple turns within the coil housing;
a cutout in the coil housing that interrupts the magnetic flux-conducting metallic material; and
a Hall effect sensor aligned with the cutout.

2. The electromagnetic coil assembly of claim 1, wherein the Hall effect sensor is located at or near an outer diameter of the coil housing and operably faces inward.

3. The electromagnetic coil assembly of claim 1, wherein at least a portion of the Hall effect sensor is arranged within the cutout.

4. The electromagnetic coil assembly of claim 1, wherein the cutout extends to a forward edge of a wall of the coil housing, such that a forward side of the cutout is unbounded by the magnetic flux-conducting metallic material of the coil housing.

5. The electromagnetic coil assembly of claim 4, wherein the wall extends substantially axially and is located at an outer diameter of the coil housing.

6. The electromagnetic coil assembly of claim 4, wherein the forward edge of the wall of the coil housing extends axially forward of the multiple turns of the winding within the coil housing.

7. The electromagnetic coil assembly of claim 1, wherein a forward part of the cutout is located forward of the multiple turns of the winding, and wherein a rear part of the cutout overlaps with at least a portion of the multiple turns of the winding, such that a target space is located radially inward of a wall of the coil housing at an outer diameter of the electromagnetic coil and axially forward of the multiple turns of the winding.

8. The electromagnetic coil assembly of claim 1, wherein the cutout has a substantially rectangular shape.

9. The electromagnetic coil assembly of claim 1, wherein the coil housing has an annular cup shape with an axially open face at a front side, wherein the coil housing includes a wall that is located at an outer diameter of the coil housing, and wherein the cutout is located in the wall.

10. The electromagnetic coil assembly of claim 1 and further comprising:
a covering consisting essentially of a non-metallic material, wherein the covering covers the multiple turns of the winding within the coil housing and further covers a portion of the coil housing, and wherein the Hall effect sensor at least partially protrudes outside the covering.

11. The electromagnetic coil assembly of claim 1 and further comprising:
an electrical connector located adjacent to the Hall effect sensor, the electrical connector configured to be matingly engageable to another connector to form one or more external electrical connections, wherein the electrical connector is electrically connected to the winding, and wherein the electrical connector is electrically connected to the Hall effect sensor.

12. A viscous clutch assembly comprising:
a rotor;
a housing rotatable relative to the rotor;
a working chamber located between and exposed to both the rotor and the housing;
a reservoir to hold a supply of a shear fluid;
a valve assembly that is magnetically controllable to regulate flow of the shear fluid between the reservoir and the working chamber; and
the electromagnetic coil assembly of claim 1, wherein the valve assembly and the electromagnetic coil assembly are operably connected by way of a flux circuit, and wherein the electromagnetic coil assembly is rotationally stationary.

13. The viscous clutch assembly of claim 12 and further comprising:
a flux guide that passes through a portion of the housing, the flux guide including a rear portion having a target, wherein the rear portion is positioned adjacent to the Hall effect sensor, separated by a gap, such that the target is rotatable through a sensing region of the Hall effect sensor.

14. A viscous clutch assembly comprising:
a rotor;
a housing rotatable relative to the rotor;
a working chamber located between and exposed to both the rotor and the housing;
a reservoir to hold a supply of a shear fluid;
a valve assembly that is magnetically controllable to regulate flow of the shear fluid between the reservoir and the working chamber; and
an electromagnetic coil assembly, wherein the valve assembly and the electromagnetic coil assembly are operably connected by way of a flux circuit, the electromagnetic coil assembly including:
a coil housing made of a magnetic flux-conducting metallic material;
a winding that forms multiple turns within the coil housing; and
an electrical connector configured to be matingly engageable to another connector to form one or more external electrical connections, the electrical connector including:
an inner electrical conductor portion that provides one or more discrete electrical connections, at least one of which is electrically connected to the winding, wherein the inner electrical conductor portion is configured to form a seal with another connector upon engagement to another connector; and
one or more fastener openings each located alongside the inner electrical conductor portion, wherein the electromagnetic coil assembly is rotationally stationary, and wherein at least one of the one or more fastener openings establishes an anti-rotation tether point for the electromagnetic coil assembly.

15. The viscous clutch assembly of claim 14, wherein the electrical connector further includes:
a mechanical engagement component on or along the inner electrical connection configured to provide a structural mechanical connection to another connector upon engagement thereto.

16. The viscous clutch assembly of claim 15, wherein the mechanical engagement component is selected from the group consisting of (a) a non-circular plug or socket component, (b) one or more detent prongs or detent apertures, and (c) combinations thereof.

17. The viscous clutch assembly of claim 14, wherein the electromagnetic coil assembly further comprises:
a cutout in the coil housing that interrupts the magnetic flux-conducting metallic material; and
a Hall effect sensor aligned with the cutout, wherein at least one of the one or more discrete electrical connections of the inner electrical conductor portion of the electrical connector is electrically connected to the Hall effect sensor.

18. The viscous clutch assembly of claim 17 and further comprising:
a flux guide that passes through a portion of the housing, the flux guide including a rear portion having a target, wherein the rear portion is positioned adjacent to the Hall effect sensor, separated by a gap, such that the target is rotatable through a sensing region of the Hall effect sensor.

19. The viscous clutch assembly of claim 18, wherein the rear portion of the flux guide having the target is arranged to be rotatable in a target space located radially inward of a wall of the coil housing and axially forward of the multiple turns of the winding within the coil housing, and wherein the Hall effect sensor is located at or near an outer diameter of the coil housing and operably faces inward toward the target space.

20. The viscous clutch assembly of claim 17, wherein the cutout is configured as a notch that extends to a forward edge of a wall of the coil housing, such that a forward side of the cutout is unbounded by the magnetic flux-conducting metallic material of the coil housing.

21. The viscous clutch assembly of claim 17, wherein at least a portion of the Hall effect sensor extends into the cutout.

22. The viscous clutch assembly of claim 14, and further comprising:
a covering consisting essentially of a non-metallic material, wherein the covering covers the multiple turns of the winding within the coil housing, covers at least a portion of the electrical connector, and further covers a portion of the coil housing.

23. The viscous clutch assembly of claim 22, wherein the electromagnetic coil assembly further comprises:
a cutout in the coil housing that interrupts the magnetic flux-conducting metallic material; and
a Hall effect sensor aligned with the cutout, wherein at least one of the one or more discrete electrical connections of the inner electrical conductor portion of the electrical connector is electrically connected to the Hall effect sensor,
wherein the Hall effect sensor at least partially protrudes outside the covering, wherein the covering is a polymer material, and wherein the covering encapsulates at least the electromagnetic coil assembly and the electrical connector together as a single unit

24. The viscous clutch assembly of claim 14, wherein the coil housing has an annular cup shape with an axially open face at a front side.

25. The viscous clutch assembly of claim 14 and further comprising:
a center shaft that is rotatable; and
a set of bearings, wherein the electromagnetic coil assembly is supported on the center shaft by the set of bearings.

26-37. (canceled)
